(19) United States
(12) Patent Application Publication
(10) Pub. No.: US 2009/0045297 A1
(43) Pub. Date: Feb. 19, 2009

(54) Device for checking the end positions of movable parts of a railway switch

(75) Inventors: Herbert Achleitner, Zeltweg (AT); Martin Meieregger, Kindberg (AT); Wolfgang Oberhoffner, Zeltweg (AT)

Correspondence Address: CHAPMAN AND CUTLER, 111 WEST MONROE STREET, CHICAGO, IL, 60603, US

(73) Assignees: VAE Eisenbahnsysteme GmbH, Zeltweg (AT); VAE GmbH, Vienna (AT)

(21) Appl. No.: 11/920,581

(22) PCT Filed: May 10, 2006
(86) PCT No.: PCT/AT2006/000192

§ 371 Date: Nov. 16, 2007

(30) Foreign Application Priority Data
May 18, 2005 (AT) A 847/2005

(51) Int. Cl. B61L 5/10; E01B 7/22; E01B 7/20; H01H 15/14

(52) U.S. Cl. 246/220; 246/449

(57) ABSTRACT

In a device for checking the end positions of movable parts of a railway switch, in which at least one separate end-position checking device (5, 6) is assigned to each movable switch part (3, 4), wherein the end-position checking device (5, 6) includes a rod (8) and a checker housing (9) in which the rod (8) is inserted and in which at least one limit switch (21, 22) is arranged to detect the two end positions of the movable switch part (3, 4), the rod (8) in its portion reaching into the housing (9), or the housing (9), comprises at least two axially spaced-apart switching flanks for the actuation of the at least one limit switch (21, 22), wherein at least one of said switching flanks is arranged to be axially displaceable relative to the other of said switching flanks and fixable in the respective position.

The invention relates to a device for checking the end positions of movable parts of a railway switch, in which at least one separate end-position checking device is assigned to each movable switch part, wherein the end-position checking device includes a rod and a checker housing in which the rod is inserted and in which at least one limit switch is arranged to detect the two end positions of the movable switch part.

Operating devices for movable switch parts such as, in particular, tongue rails or movable frogs, which are provided with end position checking devices are generally known as belonging to the prior art. In those known switch setting devices, the mechanical setting of a movable switch part is effected by the aid of an electric or hydraulic switch actuator, wherein a separate locking device, or a locking device integrated in the switch actuator, as well as, in any event, a separate end-position checking device are provided besides the switch actuator. Such end-position checking devices serve to mechanically scan in railway switches the current state of a switch, and to generate a check signal to reliably determine whether the switch has been set correctly and whether the closed tongue and the open tongue are in their respectively correct end positions. The end-position checking device comprises a check rod assembly extending substantially transverse to the longitudinal direction of the rails and which is displaced in the longitudinal direction of the rod assembly at a change-over of the switch. The positions of the checker rods are detected by the aid of electromechanical transducers formed, for instance, by limit switches or tongue checking pads, which are arranged in housings usually mounted (laterally) on a sleeper of the railway switch.

In addition to the configuration as a separate device, an end position checker also has already been integrated in a common housing with the switching drive. Another embodiment has become known from DE 29917829 U1, in which a throughgoing checker rod is provided, the two rod sections of which are telescopically guided within each other with a spring element being interposed. The end-position contact switches in that case are designed as switching fingers rigidly connected with the checker rod and cooperating with proximity switches. Alternatively, solutions are known, where grooves are provided in the checker rod for the engagement of switch levers, which will thereby enable the triggering of the limit switch. An example in this context is U.S. Pat. No. 5,669,587.

In the above-described end-position checking devices, a common checker rod is assigned to both tongue rails of a switch such that the end positions of both tongue rails can be checked by a single device. However, end-position checking devices in which each tongue rail is associated with a separate end-position checking device have already been known too, so that an increased mechanical safety is reached by the complete mechanical decoupling of the two checking devices each assigned to a single tongue rail. In this respect, it is, for instance, referred to DE 1963464 U. In that device, a separate switch rod each abuts on one switch tongue under the action of a pressure spring, with a limit switch arranged within a housing being actuated as a function of the switch position. By the rod being resiliently pressed at the switch tongue, a play-free transmission of the movement of the switch tongue to the checking device is ensured so as to enable the precise detection of the respective end positions. However, such a device involves the disadvantage that an adaptation of the end-position checking device to different setting strokes is feasible only with considerable difficulties, i.e., only by opening the checker housing and changing the position of the actuating members for the limit switches relative to the limit switches.

With modern railway switches, it is necessary to arrange a plurality of end-position checking devices along the longitudinal direction of the switch in order to be able to check the correct assumption of the respective end positions on a plurality of points. In this manner, a break of the railway switch or bulging of the same or any other malfunctioning will be more readily detected. If a plurality of end-position checking devices is to be arranged along a railway switch, each of the checking devices has to be adapted to a different setting stroke, wherein near the point of fixation of the tongue rail a setting stroke is observed that is smaller than on the free end of the tongue rail, where the maximum setting stroke occurs.

The present invention aims to provide an end-position checking device which renders feasible in a simple manner the adaptation to the different displacement paths, of movable switch parts without involving complex modification operations and, in particular, having to open the checker housing. The adaptation to different displacement paths is to be feasible even in the installed state of the end-position checking device, for instance, in order to enable a subsequent adaptation to changes in the setting stroke due to operation-inherent wear phenomena.

To solve this object, the device according to the invention is substantially configured in a manner that the rod in its portion reaching into the housing, or the housing, comprises at least two axially spaced-apart switching flanks for the actuation of said at least one limit switch, wherein at least one of said switching flanks is arranged to be axially displaceable relative to the other of said switching flanks and fixable in the respective position. By providing at least two axially spaced-apart switching flanks for the actuation of the limit switch(es), it is rendered feasible to carry out an adaptation to different displacement paths of the tongue rail by changing the axial distance between the two switching flanks. To this end, at least one of the switching flanks is arranged to be displaceable in the axial direction relative to the other switching flank and fixable in the respective position. This will, in particular, be of advantage if a separate end-position checking device is assigned to every tongue rail, so that the adaptation to different displacement paths can be separately effected for every tongue rail. On account of the possibility to precisely adjust the checking device, already slight deviations from the end position will prevent the actuation of the limit switch such that the respective malfunctioning will be immediately apparent at the control point.

The reliable functioning of the end-position checking device will only be safeguarded, if the perfect guidance of the checker rod within the housing is ensured. The end-position checking device, however, is mostly subjected to mechanical loads, for instance by the effect of vibrations transmitted from the tongue rail to the checking device, by thermal stresses or by bending or torsional moments. It is, therefore, provided in a preferred manner that the housing is configured as a tube having a circular cross section, into which the rod is sealingly inserted. On account of the circular cross section of the housing, the functionability of the end-position checking device will not be impaired even under torsional loads or at a torsion of the checker rod assembly and, in particular, checker rod, whereby the tight closure of the checker housing will in any event be maintained in the region of insertion of the checker rod in the checker housing on account of the circular configuration. Such a configuration, moreover, ensures a particularly compact mode of construction so as to be able to take into account, in the optimum manner, the limited space conditions available in the region of a switch tongue.

As a rule, the rod-shaped structural part in end-position checking devices is designed as a checker rod coupled with the movable switch part and inserted in a stationary housing, wherein the limit switches are rigidly connected with the stationary housing. As a variation, it is provided according to a preferred embodiment of the present invention that the rod is connected with a stationary part of the switch and the tube is coupled to the movable part, which will be of particular advantage, if, as in correspondence with a further preferred embodiment, the at least one limit switch is connected with the rod and capable of being actuated by the switching flanks arranged on the inner jacket of the tube. Hence, a particularly compact mode of construction will be obtained. The switching flanks for the actuation of the limit switches in this embodiment are, thus, arranged on the movable housing so as to cooperate with the limit switches arranged on the rod connected with a stationary part of the railway switch. With such a configuration, the axial displacement of the switching flanks provided in the tube, for the adjustment of the distance between the two switching flanks and, hence, the adaptation to the respective setting stroke is substantially facilitated, wherein it is provided in a preferred manner that switching grooves defined by the switching flanks are formed on the inner jacket of the tube. The limit switches are, thus, able to engage in such switching grooves as the respective end position is reached, wherein it is preferably provided for the adjustment of the distance between the switching grooves that at least one of the switching flanks is formed on a structural component that is axially displaceable relative to the tube. The displaceable structural component in this case may be designed as an inner tube capable of being screwed into the tube so as to enable a displacement of the switching flank in the axial direction by rotating the inner tube relative to the housing tube. With such a configuration, the adjustment of the switching flanks and, hence, the adaptation to the respective setting stroke can also be effected with an already installed end-position checking device without having to open the housing, since only the housing tube, which is accessible from outside, need be rotated relative to the inner tube.

In a preferred manner, the at least one limit switch comprises a spring-loaded tappet, or cooperates with a spring-loaded actuating member, which, with the movable switch part assuming the correct end position, engages in the switching groove defined by the switching flank. Due to the spring-loaded tappet, or the spring-loaded actuating member, it is ensured that the tappet or actuating member, respectively, acts against the enveloping tube in a manner that a compulsive actuation of the change-over switch will always occur, if the tongue rail has not yet reached the required end position. It is only when reaching the end position, that the spring-loaded tappet, or the spring-loaded actuating member, will engage in the respective switching groove arranged on the inner circumference of the enveloping tube. To increase the safety, at least two limit switches are preferably provided, each of the limit switches being actuatable by an associated switching flank. With the appropriate connection of the two limit switches, the reliable control of the correct assumption of the respective end position will be ensured.

The coupling of the end-position checking device to the movable railway switch part in a preferred manner is effected in that the tube, or the inner tube, comprises a connection site for a connection piece for coupling to the movable switch part. In order to ensure that merely the forces acting in the direction of the switching movement are transmitted to the end-position checking device and the end-position checking device is kept free of any other forces caused, for instance, by longitudinal displacements, thermal expansions or tilting of the tongue rail, it is preferably provided that the tube is connected with the movable switch part so as to be displaceable in the longitudinal direction of the rail. It may, moreover, be provided that the tube is connected to the movable switch part so as to be pivotable about an axis extending parallel with the longitudinal axis of the rail. The pivotal mounting may be realized using elastic connecting members and/or spherical bearings such that vibrations of the tongue rails will be balanced rather than transmitted to the checking device. Actuations of the limit switches exclusively on grounds of such vibrations are, thus, excluded, so that the reliability of the checking device will be enhanced. Tilting moments or the like acting on the movable switch parts when running over a switch are likewise taken up by the joint or elastic connecting member due to the pivotability of the checking device.

In order to further enhance the usability of the end-position checking device on various points along a railway switch, the configuration is advantageously further developed in a manner that the rod is connected with a sliding block which is capable of being displaced in the axial direction relative to a stationary bearing pedestal. It is thereby feasible to displace the entire end-position checking device in a direction transverse to the longitudinal direction of the rail so as to ensure the improved adaptation to various setting strokes. In particular, it is thereby feasible to arrange one and the same end-position checking device on different points along a switch, with the effective length of the checker rod assembly being adjustable on account of the axial displaceability of the end-position checking device. The displaceability may readily be obtained in that the stationary bearing pedestal carries a spindle extending transverse to the longitudinal direction of the rail and cooperating with an internal thread of the sliding block. By rotating the spindle, an accordingly infinitely variable axial displacement of the checker rod assembly is, thus, feasible.

In the following, the invention will be explained in more detail by way of an exemplary embodiment schematically illustrated in the drawing. Therein:

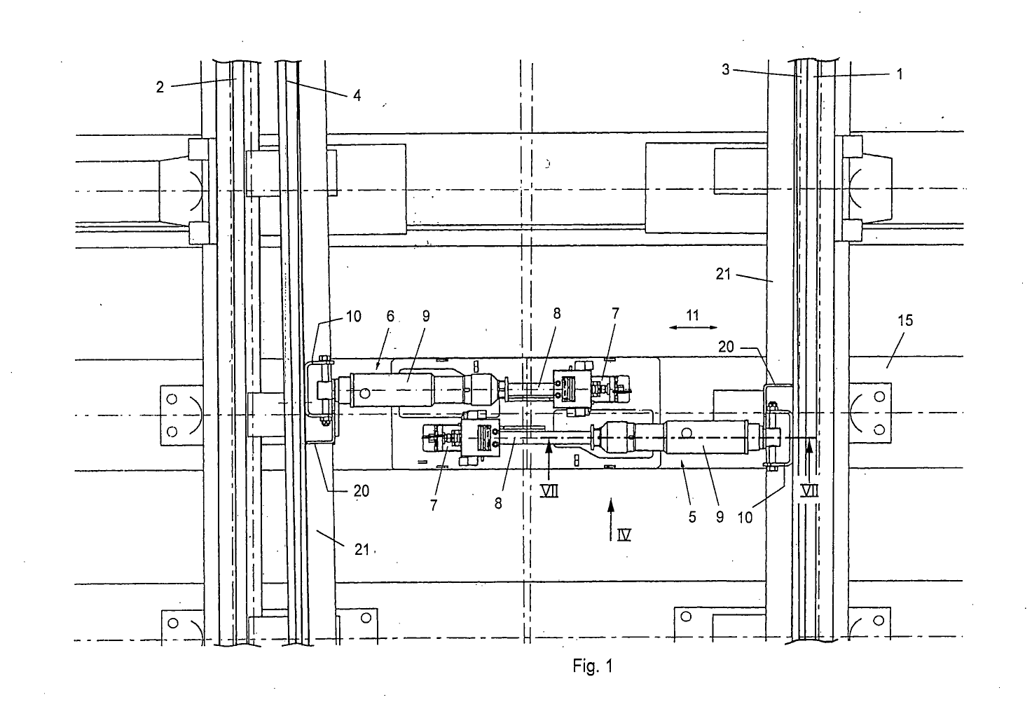

FIG. 1 is a top view on a device according to the invention comprising two parallelly arranged end-position checking devices;

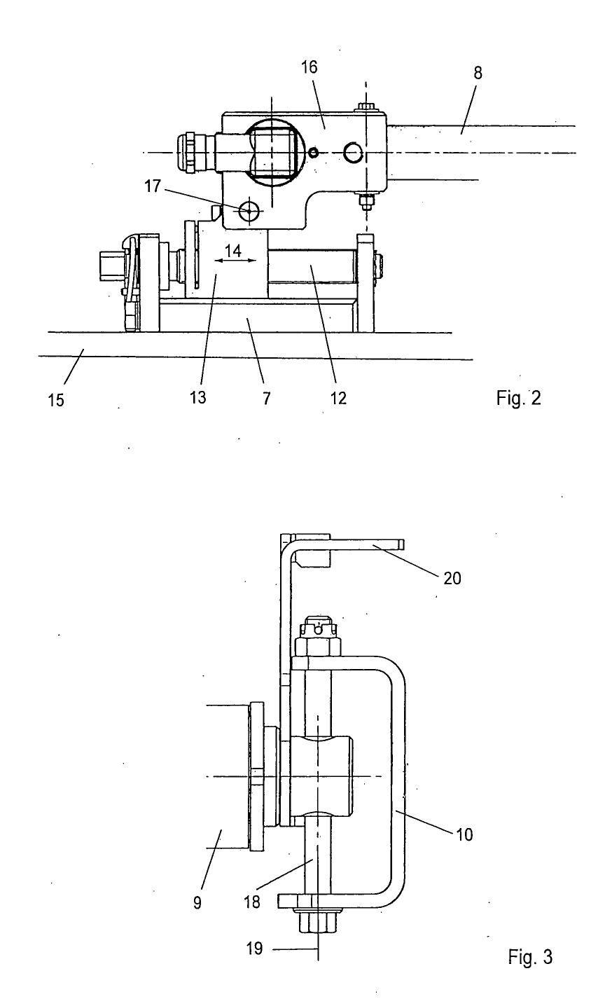

FIG. 2 is a detailed view of the fixation of the end-position checking device to a sleeper;

FIG. 3 is a detailed view of the coupling of the end-position checking device to a tongue rail;

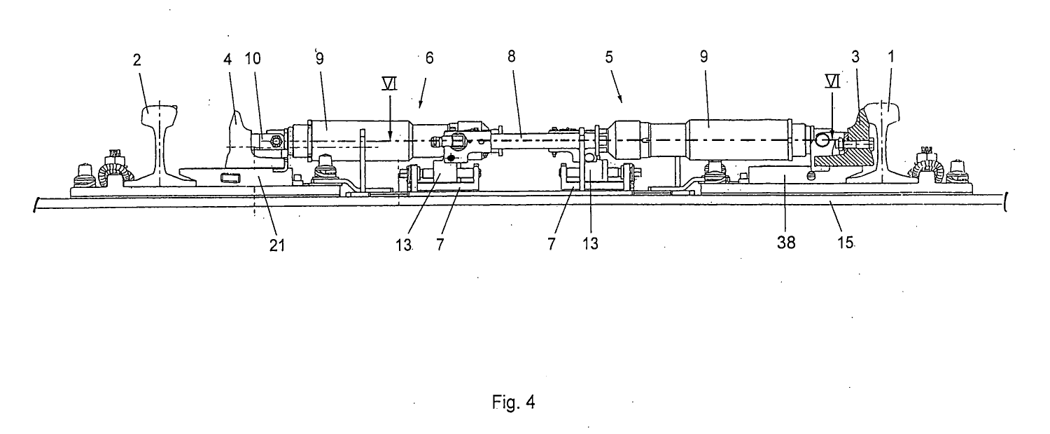

FIG. 4 is a view in the sense of arrow IV, of the device according to FIG. 1;

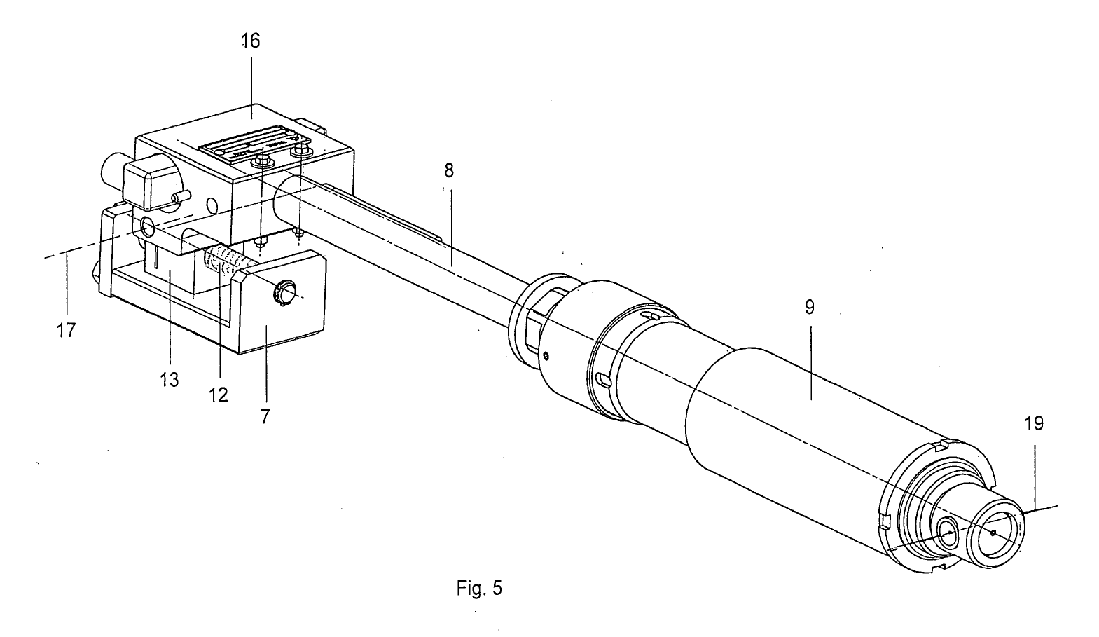

FIG. 5 is a perspective illustration of an end-position checking device;

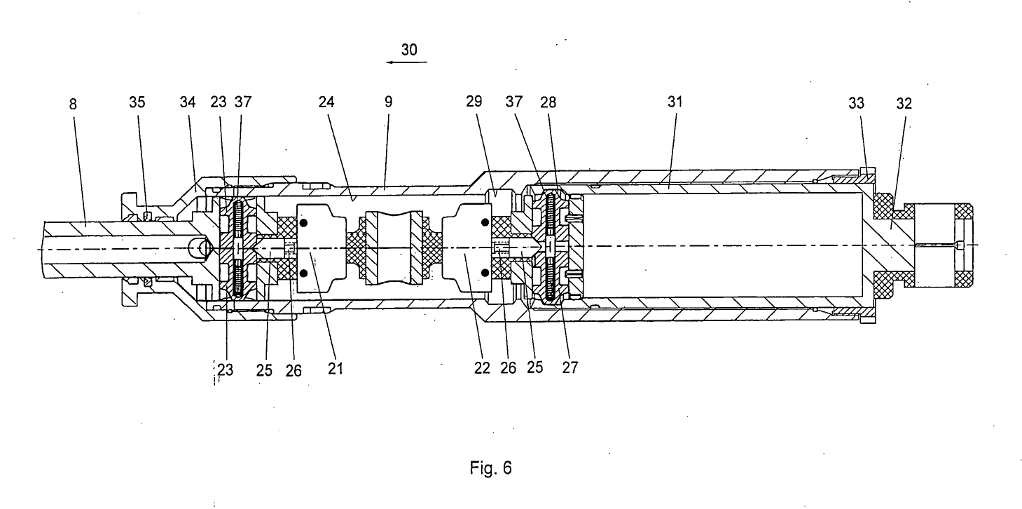

FIG. 6 is a sectional illustration of the end-position checking device along line VI-VI of FIG. 4;

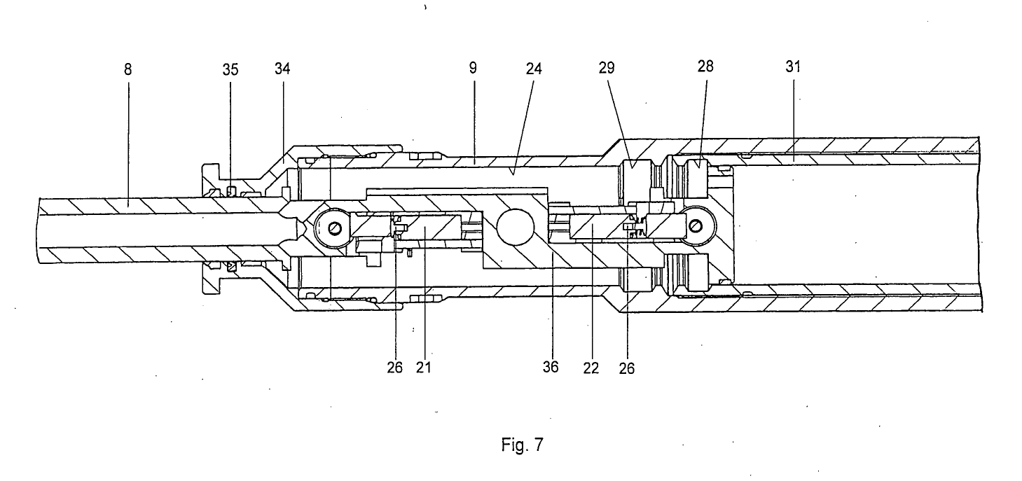

FIG. 7 is a sectional view along line VII-VII of FIG. 1; and

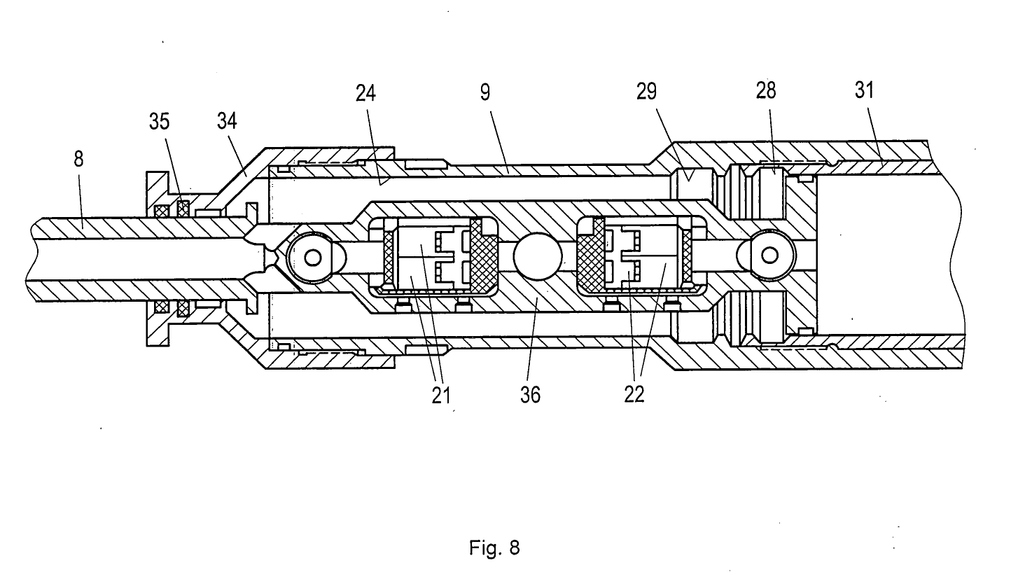

FIG. 8 is an illustration analogous to FIG. 7, of a modified configuration.

FIG. 1 depicts a section of a railway switch including stock rails 1 and 2 as well as tongue rails 3 and 4. The tongue rail 3 in this case abuts on the stock rail 1, tongue rail 4 is in a position not abuting on the stock rail 2. The tongue rails 3 and 4 are each assigned a separate end-position checking device 5 and 6, respectively, so as to ensure the complete mechanical decoupling of the tongue rails 3 and 4. The end-position checking devices 5 and 6 are each fixed to a sleeper 15 via a bearing pedestal 7. The end position checking devices are each comprised of a rod 8 which is sealingly inserted in a tubular housing 9, the tube 9 being coupled to the tongue rail 3 and 4, respectively, via an articulated fork head 10. When operating a switch along double arrow 11, the tube 9, which is coupled to the tongue rail, is carried along and displaced relative to the rod 8, whereby, as will be explained below, limit switches are actuated as a function of the relative displacement position of the tube 9 in respect to the rod 8. In the detailed illustration according to FIG. 2, the connection of the end-position checking device with the sleeper 15 is shown. A bearing pedestal 7 carrying a spindle 12 is connected with the sleeper 15. The spindle 12 is provided with an external thread which cooperates with an internal thread provided in a bore of the sliding block 13 so as to enable a displacement of the sliding block 13 in the sense of double arrow 14 by rotating the spindle 12. The end piece 16 connected with the rod 8 is articulately connected with the sliding block 13 about an axis 17 so as to prevent possible tilting moments from being transmitted to the end-position checking device.

FIG. 3 depicts in detail the coupling of the end-position checking device to the movable tongue rail. As is also apparent from the illustration according to FIG. 4, an articulated fork head 10 carrying a pin 18 is provided in a manner that the tube 9 is coupled to the tongue rail so as to be pivotable about an axis 19. The fork head 10 embraces the foot of the tongue rail and is fixed to the rail web by a screw connection. A holding plate 20 serves to fix the position of the end-position checking device in the longitudinal direction of the rail by being laterally supported on the sliding chair 38. This configuration prevents any longitudinal expansion of the rail from being transmitted to the checking device. The holding plate 20 further includes a vertically oriented longhole, which is not visible in the Figure and by which the fork head 10 is relieved of vertical forces.

The mode of functioning of the end-position checking device will now be explained in more detail by way of the sectional illustration according to FIG. 6. The rod 8, which is rigidly connected with the end piece 16, carries two limit switches 21 and 22 on its end that is inserted in the tube. The actuating mechanism for the limit switches is comprised of two switching tappets 23 which are arranged symmetrically to the central axis, resiliently biased relative to each other and outwardly pressed against the inner jacket 24 of the tube 9. On their mutually facing sides, the switching tappets 23 cooperate with a switching cone 25 which acts directly on the actuating tappet 26 of the limit switch. The limit switch is actuated as long as the switching tappet 23 is in the radially inwardly maintained position, which is the case with the limit switch 21 in the situation represented in the Figure. In the event of the limit switch 22, the switching tappets 27 are, by contrast, illustrated in the radially outwardly shifted position, engaging in a switching groove 28 and, hence, preventing the limit switch 22 from being further actuated. On the inner circumference of the tube 9, beside the switching groove 28, is provided a further switching groove 29 into which the switching tappets 23 of the limit switch 21 can engage at a respective setting of the switch.

During the setting procedure of the switch, the tube 9 and inner tube 31 coupled to the tongue rail are displaced in the sense of arrow 30, departing from the position illustrated in the drawing, thus causing a displacement of the switching grooves relative to the limit switches. In doing so, the switching tappets 27 are pressed radially inwardly against the force of springs 37, emerging from the switching groove 28. During the setting procedure, both the actuating tappets 23 of the limit switch 21 and the actuating tappets 27 of the limit switch 22 are, therefore, in the radially inwardly pressed position such that both of the limit switches 21 and 22 are actuated. At the end of the setting procedure, the actuating tappets 23 engage in the switching groove 29, which indicates that the correct end position has been reached. An adaptation to the respective setting stroke is then effected by a change of the distance between the switching grooves 28 and 29. The smaller the setting stroke, the larger the distance between the switching grooves 28 and 29 has to be chosen. To enable the axial displacement of the switching groove 28, the latter is formed on a separate structural component, namely the inner tube 31, which is screwed into the tube 9. By rotating the tube 9 relative to the inner tube 31, an infinitely variable adjustment of the distance between the switching grooves 28 and 29 occurs. The respectively selected rotated position is fixed by the aid of a securing nut 33. The inner tube 31 comprises a projecting end section 32 into whose annular groove the holding plate 20 engages.

From FIG. 7 it is apparent that the tight mounting of the rod 8 within the tube 9 is ensured by an overlapping part 34 which is screwed on the tube end facing the rod and carries appropriate seals 35 for the tight guidance of the rod 8. The rod 8 is further connected with a support element 36 to which the end-position contact switches 21 and 22 are fixed. The illustration according to FIG. 8 depicts a modified configuration, in which a total of four end-position contact switches are connected with the support-like structural part 36. In this case, two switches are provided for each end position, which are each switched by a common actuating mechanism. This allows for the achievement of an enhanced checking security.

1. A device for checking end positions of movable switch parts of a railway switch, comprising:
a plurality of end-position checking devices (5, 6),
wherein
each one of said plurality of end-position checking devices (5, 6) is separately assigned to each movable switch part (3, 4) of the railway switch,
each one of said plurality of end-position checking devices (5, 6) comprises a rod (8) and a checker housing (9),
the rod (8) is inserted into said checker housing (9),
at least one limit switch (21, 22) is arranged to detect two end positions of each of said movable switch parts (3, 4),
the rod (8) in its portion reaching into the checker housing (9), or the checker housing (9), comprises at least two axially spaced-apart switching flanks for actuation of said at least one limit switch (21, 22), and wherein
at least a first one of said switching flanks is arranged to be axially displaceable relative to a second one of said switching flanks, and
said first one of said switching flanks is arranged to be fixable in a respective position of said first one of said switching flanks.

2. A device according to claim 1, wherein the checker housing (9) is configured as a tube having a circular cross section, into which the rod (8) is sealingly inserted.

3. A device according to claim 1, wherein the rod (8) is connected with a stationary part of the railway switch, and the checker housing (9) is coupled to the movable switch part (3, 4).

4. A device according to claim 1, wherein
the at least one limit switch (21, 22) is connected with the rod (8), and
the at least one limit switch (21, 22) is arranged to be actuated by the switching flanks arranged on an inner jacket (24) of the checker housing (9).

5. A device according to claim 1, wherein the rod (8) comprises a bore for passage of a wiring for the at least one limit switch (21, 22).

6. A device according to claim 1, wherein switching grooves (28, 29) defined by the switching flanks are formed on an inner jacket (24) of the checker housing (9).

7. A device according to claim 1, wherein at least one of the switching flanks is formed on a structural component that is displaceable in an axial direction relative to the checker housing (9).

8. A device according to claim 7, wherein the displaceable structural component is designed as an inner tube (31) adapted to being screwed into the checker housing (9).

9. A device according to claim 6, wherein the limit switch (21, 22) comprises a spring-loaded tappet (26) which, with the movable switch part assuming a correct end position, engages in the switching groove (28, 29) defined by the switching flank.

10. A device according to claim 1, wherein at least two limit switches (21, 22) are arranged to detect the end positions of each of said movable switch parts (3, 4), and each of said limit switches (21, 22) is actuatable by an associated switching flank.

11. A device according to claim 1, wherein the checker housing (9) comprises a connection site for a connection piece for coupling to a movable switch part (3, 4).

12. A device according to claim 1, wherein the checker housing (9) is connected with the movable switch part (3, 4) in a manner displaceable in a longitudinal direction of a rail.

13. A device according to claim 1, wherein the checker housing (9) is connected to the movable switch part (3, 4) so as to be pivotable about an axis (19) extending parallel with a longitudinal axis of a rail.

14. A device according to claim 1, wherein the rod (8) is connected with a sliding block (13) which is displaceable in an axial direction relative to a stationary bearing pedestal (7).

15. A device according to claim 14, wherein the rod (8) is connected to the sliding block (13) so as to be pivotable about an axis (17) extending parallel with a longitudinal direction of a rail.

16. A device according to claim 14, wherein the stationary bearing pedestal (7) carries a spindle (12) extending transverse to a longitudinal direction of a rail and cooperating with an internal thread of the sliding block (13).

17. A device according to claim 2, wherein the rod (8) is connected with a stationary part of the railway switch, and the checker housing (9) is coupled to the movable switch part (3, 4).

18. A device according to claim 3, wherein
the at least one limit switch (21, 22) is connected with the rod (8), and
the at least one limit switch (21, 22) is arranged to be actuated by the switching flanks arranged on an inner jacket (24) of the checker housing (9).

19. A device according to claim 6, wherein the limit switch (21, 22) cooperates with a spring-loaded actuating member (23, 27), which, with the movable switch part assuming a correct end position, engages in the switching groove (28, 29) defined by the switching flank.

20. A device according to claim 8, wherein the inner tube (31) comprises a connection site for a connection piece for coupling to a movable switch part (3, 4).
